(19) United States
(12) Patent Application Publication
(10) Pub. No.: US 2022/0048678 A1
(43) Pub. Date: Feb. 17, 2022

(54) PACKAGING BAG ON A PAPER BASIS, AS WELL AS METHOD FOR THE PRODUCTION OF A PACKAGING BAG

(71) Applicant: Mondi AG, Wien (AT)

(72) Inventors: Jens KOESTERS, Wallenhorst (DE); Alfons KRUSE, Dinklage (DE); Jochen BRAUER, Lohne (DE)

(73) Assignee: Mondi AG, Wien (AT)

(21) Appl. No.: 17/401,634

(22) Filed: Aug. 13, 2021

(30) Foreign Application Priority Data
Aug. 14, 2020 (DE) 10 2020 004 962.1

(51) Int. Cl. B65D 33/02; B65D 30/08; B31B 70/62; B31B 70/16

(52) U.S. Cl. CPC B65D 33/02; B65D 31/02; B31B 2155/00; B31B 70/16; B31B 70/62

(57) ABSTRACT

A packaging bag has a bag body on a paper basis, which has front walls that lie opposite one another, side walls arranged between the front walls, and longitudinal edges that connect the front walls with the side walls. A material section that forms the assigned front wall and a material section that forms the assigned side wall, are connected with one another on the longitudinal edges to form a reinforcement fold that runs in the longitudinal direction, by way of a fixation layer that borders on each longitudinal edge. The fixation layer assigned to at least one of the reinforcement folds is an adhesive layer, wherein regions of the bag body between the reinforcement folds are free of an adhesive layer.

### CROSS REFERENCE TO RELATED APPLICATIONS

Applicant claims priority under 35 U.S.C. § 119 of German Application No. 10 2020 004 962.1 filed Aug. 14, 2020, the disclosure of which is incorporated by reference.

### BACKGROUND OF THE INVENTION

### 1. Field of the Invention

The present invention relates to a packaging bag having a bag body on a paper basis, which has front walls that lie opposite one another, side walls arranged between the front walls, and longitudinal edges that connect the front walls with the side walls, wherein a material section that forms the assigned front wall and a material section that forms the assigned side wall, in each instance, are connected with one another on at least one of the longitudinal edges, directly or indirectly, by way of a fixation layer that borders on the longitudinal edge, in each instance, to form a reinforcement fold that runs in the longitudinal direction. Fundamentally, reinforcement folds can be provided on all the longitudinal edges. However, within the scope of the invention it is also sufficient if a reinforcement fold is provided only on one, on two or on three longitudinal edges.

Within the scope of the invention, a bag body on a paper basis means an embodiment in which the bag body is either formed entirely of paper or has a multilayer embodiment in which at least one, multiple or preferably all the layers are formed from a paper, wherein, however, at least the fixation layer follows a paper layer directly.

### 2. Description of the Related Art

The formation of reinforcement folds in packaging bags is fundamentally known from the state of the art and serves to increase the rigidity of the bag body. Thus, for example, WO 01/24999 A1 describes a packaging bag made from film material, wherein reinforcement folds directed either inward or outward are formed by means of heat-sealing corresponding material sections of an assigned side wall and an assigned front wall. Accordingly, the film material has a heat-sealable coating, for example composed of polyethylene or, alternatively, is formed entirely from a heat-sealable material, so that accordingly, the corresponding material sections can be connected with one another merely by means of the introduction of heat, without an additional layer having an adhesive effect having to be applied. Furthermore, the possibility is also described of forming an additional functional space by way of a corresponding configuration of the reinforcement fold, into which space straws or other objects can be introduced, for example. However, the reinforcement folds formed within the scope of this invention are preferably not provided for formation of an additional functional space.

A similar manner of the introduction of reinforcement folds is known from EP 2 284 090 B1, for example.

Specifically with regard to good recyclability of packaging materials, packaging bags that are formed entirely or at least essentially of paper are increasingly coming into focus, for example for packaging foods or also animal feeds. Aside from good recyclability, the fact that the fibers required for the production of paper are based on renewable resources, so that in total, a high recycling rate can be achieved, also plays a decisive role. Usually, an attempt is made to reach a recycling rate of more than 80% by weight, preferably more than 90% by weight, particularly preferably more than 95% by weight. However, bag bodies on a paper basis have only very low shape retention. This can make itself noticed, specifically at low grammages of the paper, by means of unintentional bulging of the filed packaging bag, and thereby the optical appearance is negatively influenced. For this reason, the introduction of reinforcement folds is also desirable in the case of such bag bodies. In contrast to plastic films, however, in the case of paper heat-sealing is fundamentally only possible if the paper is coated with a heat-sealable surface.

In this connection, DE 1 807 453 U forms a prior art document of the stated type; it describes a paper packaging bag having reinforcement seams, in which the reinforcement folds are formed by means of a heat-sealable polymer coating as a fixation layer.

However, such an embodiment has the disadvantage that the paper layers cannot be separated from the polymer layer, or at least can be separated only with difficulty, and therefore the two materials cannot be recycled individually, so that in total only a very poor recycling rate occurs.

### SUMMARY OF THE INVENTION

Against this background, the present invention is based on the task of indicating a packaging bag as well as a method for the production of such a packaging bag, in which the shape retention is increased by means of the formation of reinforcement seams, and, at the same time, a high recycling rate can be achieved.

The object of the invention and the solution for the task is a packaging bag in a bag body on a paper basis, which has front walls that lie opposite one another, side walls arranged between the front walls, and longitudinal edges that connect the front walls with the side walls, wherein a material section that forms the assigned front wall and a material section that forms the assigned side wall, in each instance, are connected with one another on at least one of the longitudinal edges by way of a fixation layer that borders on the longitudinal edge, in each instance, to form a reinforcement fold that runs in the longitudinal direction. Accordingly, the fixation layer assigned to the at least one reinforcement fold is an adhesive layer, wherein regions of the bag body between the reinforcement folds are free of an adhesive layer. Preferably all the reinforcement folds are formed using a fixation layer composed of adhesive. Therefore the adhesive layer is not a full-area coating with a heat-sealable material, for example. Instead, a separate adhesive layer is applied as a fixation layer only in the regions of the reinforcement fold, in targeted manner, by way of which layer material sections of a front wall and a side wall can be connected with one another section by section.

The regions of the bag body that are free of such an adhesive layer relate to the same side, in particular to the inner side of the packaging body, so that accordingly, adhesive layers are arranged only on regions that are at a distance from one another on one side of the bag body. Fundamentally, the reinforcement folds can extend into the bag body both to the outside or, alternatively, into the inside. However, within the scope of the invention an embodiment is preferred in which the reinforcement folds are directed outward, so that the adhesive layers and also the regions that are free of an adhesive layer relate to the inner side of the bag body.

According to a preferred embodiment of the invention, the adhesive layer or the adhesive layers assigned to the individual reinforcement folds are formed from a glue or from a hot-melt adhesive. The glue is preferably a water-soluble glue on a starch basis, which contains no solids or only a small proportion of solids. A hot-melt adhesive is an adhesive that achieves its adhesion effect by way of physical hardening. Hot-melt adhesives are solid at room temperature and become able to be processed by being melted. In this regard, the hot-melt adhesive is applied in the melted state, wherein then fixation takes place during the course of cooling.

In order to be able to fix the reinforcement fold in place by means of the fixation layer, various embodiment variants have proven to be particularly practical, wherein usually, during the course of production, the material sections of the assigned front wall and side wall are folded over onto one another in such a manner that a corresponding reinforcement fold is formed, in which the material sections lie opposite one another, at least essentially, and either border directly on one another or form a correspondingly small cavity. The adhesive layer can then be arranged, at least in part, within the assigned material sections or directly between the two material sections, and then connect the material sections of the assigned front wall and side wall directly with one another. Therefore adhesive introduction takes place directly into the reinforcement fold, so that a three-layer structure occurs in the reinforcement fold, consisting of the material plies of the front wall and the side wall, as well as of the adhesive layer. Such an embodiment has the advantage that it can be produced very easily by means of suitable process management, wherein, however, the adhesive borders directly on the interior of the bag body and therefore can come into contact with the packaged material, so that accordingly, the adhesive must possess a corresponding approval for packaged foods if these are packaged in the bag.

Supplementally or alternatively, an embodiment can therefore be provided in which the adhesive layer is arranged outside of the assigned reinforcement fold, at least in part, and at least one additional material ply on a paper basis connects the material sections of the front wall and of the side wall with one another. In this regard, the at least one additional material ply is preferably arranged in such a manner that it covers the opening formed by the reinforcement fold, so that accordingly, it is arranged in the interior of the bag body in the case of reinforcement folds that project outward. Accordingly, adhesive application also takes place outside of the reinforcement folds, wherein this adhesive application is provided merely for the purpose of connecting the additional material ply with the assigned front wall and side wall. In contrast to the introduction of an adhesive layer directly into the reinforcement fold, indirect connection or fixation of the reinforcement fold therefore takes place by way of the at least one additional material ply. For this purpose, the at least one additional material ply can be structured in strip form, for example, and extend only in the longitudinal direction in the region of the corresponding reinforcement fold. In the case of a bag body consisting of two side walls and two front walls and, accordingly, four reinforcement folds, four strip-shaped additional material plies would accordingly also be necessary so as to fix the reinforcement folds in place.

Alternatively, however, the at least one additional material ply can also be a tube-shaped material ply, which encloses the front walls and the side walls. Therefore only one material ply would then be required so as to be able to fix all four reinforcement folds in place, for example. Independent of the precise embodiment of the at least one additional material ply, however, corresponding fixation still takes place by way of one adhesive layer, in each instance, on all the reinforcement folds, since a connection between the corresponding material sections of the front wall and side wall must take place on all the reinforcement folds.

The use of one or more additional material plies has the advantage that the adhesive does not come into direct contact with the packaged goods, since the adhesive layer is covered by the additional material ply. In this regard, it is also conceivable, of course, that in spite of the additional material ply, adhesive introduction takes place directly into the bag fold. However, due to the fact that the material ply closes off the opening formed by the reinforcement fold, an effective boundary between the region of the reinforcement fold and the interior of the bag body is created.

Fundamentally, multiple material plies, for example two material plies can also be arranged one on top of the other within the scope of the invention, wherein such an arrangement relates to the fact that multiple material plies are arranged in the form of layers that are laid one on top of the other in the region of only one reinforcement fold. For example, it is conceivable that first a strip-shaped material ply covers the corresponding reinforcement folds and fixes them in place by way of an adhesive layer, in each instance, wherein subsequently a further continuous tube-shaped material ply that encloses the front and side walls is provided above these strip-shaped material plies. Such an embodiment has the advantage that the adhesive of the strip-shaped material plies has sufficient time to harden during the course of production, since the innermost continuous material ply is arranged on the strip-shaped material plies first, and the bag tube is only formed afterward. The innermost material ply, which encloses the bag body from the inside, can furthermore be connected with the bag body by way of additional adhesive layers. Preferably, however, attachment by way of adhesive layers that run in the longitudinal direction does not take place. Instead gluing merely takes place in the head region and bottom region of the packaging bag, which is necessary in any case so as to close the packaging bag.

Alternatively, a continuous material ply that encloses the front and side walls can first be provided, so as to fix the reinforcement folds in place to a certain degree, wherein then the additional material ply projects into the corresponding reinforcement fold in the region of the fold, section by section, and is thereby folded over to a certain extent itself. In this region, a strip-shaped additional material ply can then be arranged, in each instance, which ply fixes the material ply that borders on the bag body in place.

Independent of the concrete embodiment of the packaging bag, the bag is formed from kraft paper, entirely or at least with one layer. Kraft paper is understood to be a packaging paper that is formed from unbleached sulfate pulp and has high static and dynamic strengths. For this reason, such kraft paper is frequently used for packaging materials. If only one layer is formed from kraft paper, this is preferably the layer that lies on the inside or the layer that forms the interior of the bag body. The inner layer of the bag body can furthermore also be formed with a fat barrier, wherein then the inner layer is modified accordingly so as to prevent penetration of media through the bag body. Such a fat barrier can be formed by way of a thin coating, for example of polyvinyl alcohol (PVOH), but this does not allow any connection or sealing. Furthermore, a coating with polyvinyl alcohol can also act as a substratum for an additional printed layer. Since polyvinyl alcohol is soluble in water, this impairs recyclability only slightly.

Alternatively or supplementally, the individual fibers can also be coated, chemically modified and/or the interstices between the fibers can be filled with microfibers, for example. However, such modification is not equivalent to coating the bag body with a heat-sealable polymer layer, particularly one of polyolefin, for example. Such coatings are usually applied during the course of extrusion coating. However, application of a fat barrier merely involves modification of the actual paper layer, and this does not take place during the course of extrusion coating.

If different layers, in particular different paper layers are used for the bag body, preferably a coated paper is used for a layer that lies on the outside; in contrast to kraft paper, this has a higher surface quality and, above all, lower roughness, and thereby brings about a better optical appearance. Furthermore, the layer that lies on the outside can also be imprinted at good quality. In the case of such a configuration with a layer of kraft paper that lies on the inside and a layer of coated paper that lies on the outside, the outer layer has a weight per surface area between 40 and 100 g/m², and the inner layer of kraft paper has a weight per surface area between 50 and 110 g/m², in particular between 60 and 100 g/m².

With regard to the configuration of the head region and/or bottom region, multiple alternatives have proven to be particularly suitable. In order to be able to fill the bag body particularly well, it is provided, for example, that either the head region or the bottom region is firmly closed, whereas the other region, in each instance, remains open at first, so as to be able to undertake filling by way of this opening.

For example, the bottom region can be firmly closed, whereas in the head region, at least one of the front walls is configured with a sealable coating, for example with a hot-melt sealing coating, in such a manner that the front walls can be sealed to one another after the bag body has been filled, so as to close the bag body. Such a sealable coating can fundamentally be provided in the bottom region, as well, in place of the head region, wherein then the bag is closed in the bottom region after it has been filled.

The sealing coating is usually applied to the at least one front wall in a melted state and hardens there. During the course of sealing, the hot-melt adhesive is then melted again by means of the application of heat, and thereby a sealing seam can form.

So as to form a firm connection, an adhesive layer, in particular a contact adhesive is provided. The contact adhesive can be a dispersion adhesive or a glue. However, a contact adhesive composed of hot-melt adhesive is also conceivable. In general, a distinction should be made between a hot-melt adhesive sealing coating and a contact adhesive composed of hot-melt adhesive. While a sealing coating is applied and then melted again later for sealing, a contact adhesive only has to be heated once. In this melted state, such a contact adhesive is much stickier in comparison with a sealing coating, so that a connection that can withstand stress can be quickly produced, so as to be able to withstand the weight produced by the material filled into the bag. Against this background, the material for the hot-melt adhesive sealing coating and the material for the contact adhesive composed of a hot-melt adhesive can differ from one another with regard to their composition, the melting method and/or their viscosity.

Both the sealable coating and the adhesive layer are preferably arranged only in the head region or bottom region, so that no full-area coating of the inner side of the bag body takes place. The width of this sealable coating, running along the longitudinal direction, can amount to between 5 and 40 mm, preferably between 10 and 30 mm.

With regard to the closure of the bag body in the head region and/or bottom region, the sealable coating and/or the adhesive layer can be arranged on an inner side of the bag body, for example. The walls of the bag body can then be connected or sealed to one another on the inner sides, in each instance. In this connection, what is called a staggered cut is also conceivable. In this regard, one of the two front walls is configured to be shorter than the other front wall in terms of a height that runs in the longitudinal direction. The overhanging section of the longer front wall is then folded over onto the shorter front wall, in such a manner that the overhanging section of the longer front wall lies on the outer side of the shorter front wall with an inner side. An adhesive layer for the connection can then be arranged between them. If the bag is not yet supposed to be closed in this region, the longer front wall has a sealable coating for a connection of the two front walls to one another on the inner side of the overhanging section, or the shorter front wall has this on the outer side.

Alternatively or supplementally, it is also possible that an adhesive layer or a sealable coating is applied on one or on both front walls, on an outer side in the head region and/or bottom region, in each instance, and that the packaging body is closed by means of one-time or multiple folding over of the front walls in the head region and/or bottom region. The front walls are then usually configured to have the same length.

With regard to a closure in the bottom region, a cover sheet can also be introduced into the bottom region and connected with the front and side walls by way of an adhesive layer.

Furthermore, re-closures can also be provided, which make it possible to close the packaging body once again after it has been opened for the first time. In this connection, hook and loop closures are particularly preferred, wherein the individual closure elements of the hook and loop closures can be brought into contact with one another by means of folding the front walls over in the head region, and then they close off the bag body at the head end, interacting with one another. A corresponding coating can also be provided for the bottom region, so that there, too, the bag body can be closed or is closed by way of a sealing seam.

In addition to the reinforcement folds at the corresponding longitudinal edges, furthermore the side walls can also have side folds, and thereby the packaging bag can easily be laid flat in an unfilled state, wherein then side fold sections of the side walls lie one on top of the other.

By means of the reinforcement folds, it is thereby possible to achieve a great measure of shape retention in spite of the use of a relatively thin bag material, wherein the packaging bag is designed, in particular, for a filling weight between 0.5 and 15 kg, preferably between 1 and 5 kg. The packaging bag preferably has a width between 150 and 300 mm, particularly preferably between 180 and 280 mm, wherein the width relates to the width of the front walls. The height of the packaging bag, which height runs in the longitudinal direction, preferably amounts to between 350 and 800 mm, particularly preferably between 380 and 500 mm. The width of the side walls preferably amounts to between 60 and 170 mm, particularly preferably between 80 and 130 mm.

Furthermore, a method for the production of a packaging bag according to the invention is an object of the invention, wherein first a material web is supplied in the production direction, wherein the material web is pressed in at multiple positions separated from one another in the transverse direction, to form reinforcement folds, wherein an adhesive layer is applied to the material web in the region of the reinforcement folds, in each instance, which layers fix the reinforcement folds in place in the material web, wherein a material tube having front walls that lie opposite one another, side walls arranged between the front walls, and longitudinal edges that connect the front walls with the side walls is formed by means of folding of the material web, and wherein subsequently, individual bag bodies are cut off from the material tube. Formation of the reinforcement folds preferably takes place by means of the use of shaped plates, which are spaced apart from one another both in the transverse direction and in the longitudinal direction. In this way, clean folding without web distortion or wrinkle formation is achieved, since simultaneous drawing of the material web into multiple folds is avoided by means of the spacing of the shaped plates.

Accordingly, it is provided that the reinforcement folds are already introduced into the material web when it lies flat, and thereby before the formation of a material tube. For this purpose, an adhesive layer can be introduced into the reinforcement folds, at least in certain sections, for example directly through the shaped plates, in each instance, and for fixation, material sections of the material web that lie opposite one another can be directly connected with one another by way of the adhesive layer, in the region of the reinforcement folds.

Alternatively or supplementally, one or more additional material plies are connected with the material web by way of adhesive layers that are arranged outside of the reinforcement folds, at least in certain sections, wherein the material plies are arranged on the material web in such a manner that they cover the reinforcement folds. For this purpose, the material plies can already be configured to be self-adhesive. Alternatively, an adhesive layer, for example composed of glue, can be applied to the additional material plies even before application to the material web. In addition, multiple material plies can also be arranged one on top of the other, wherein it is possible to refer to the explanations regarding the packaging bag with regard to the configuration of the individual material plies.

According to a further development of the method, an overlap region that runs along the production direction forms after folding of the material web to form a material tube, which region is arranged, in particular, on one of the front walls, and preferably can be closed off by way of a previously applied adhesive layer composed of glue or a hot-melt adhesive, for example, which layer runs in the longitudinal direction. In this connection, an embodiment in which the overlap region is arranged in one of the reinforcement folds or directly next to it is particularly preferred, so that with regard to the front walls, an undisrupted appearance occurs. If multiple material plies are provided, these are preferably connected with one another by way of an overlap seam, in each instance.

Preferably, a heat-sealable coating is applied to a side of the material web that forms the inner side of the bag body, before the formation of a material tube, in multiple sections arranged one on top of the other in the production direction. In this regard, the sections are oriented based on the placement of the bag bodies to be formed from them, wherein the heat-sealable coatings are preferably provided in a section to be established as a head region.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a packaging bag according to the invention; and

FIGS. 2A, 2B, 2C show the packaging bag according to FIG. 1 in a cross-section, with reinforcement folds formed in different ways.

### DETAILED DESCRIPTION OF PREFERRED EMBODIMENTS

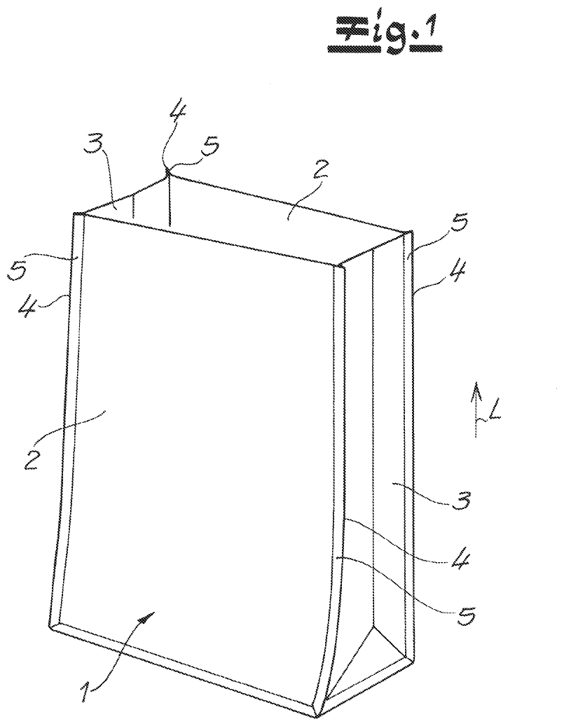

FIG. 1 shows a packaging bag having a bag body 1, which has front walls 2 that lie opposite one another, as well as side walls 3 arranged between the front walls 2, which connect the front walls 2 with one another, and wherein the front walls 2 and the side walls 3 border on one another by way of longitudinal edges 4.

Furthermore, the side walls 3 are configured with a side fold that divides the side walls 3 into two side fold halves, in each instance, which lie one on top of the other in the case of a bag body 1 that has been laid flat.

In order to impart greater rigidity to the bag body 1, reinforcement folds 5 are furthermore provided, which folds are assigned to one of the longitudinal edges 4, in each instance, and run in the longitudinal direction L.

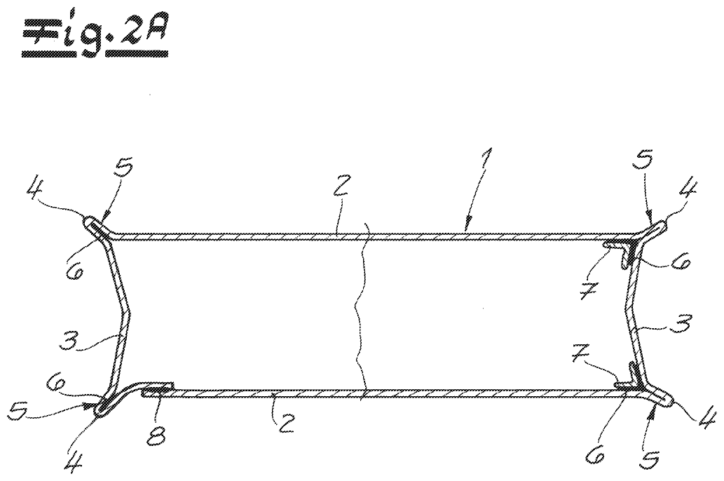

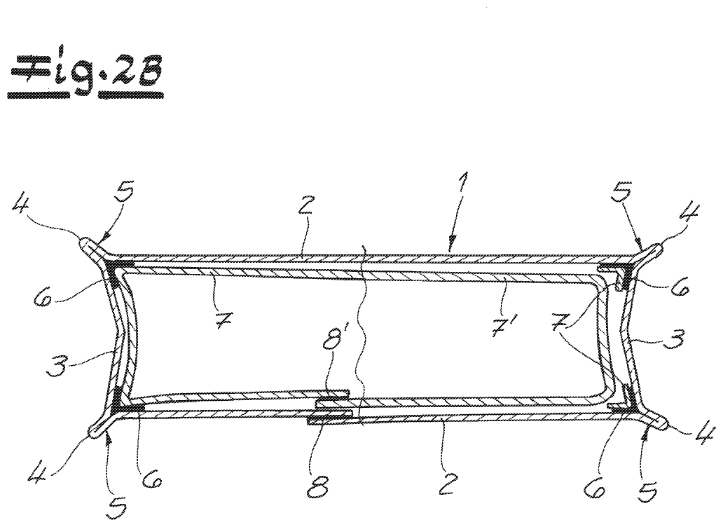

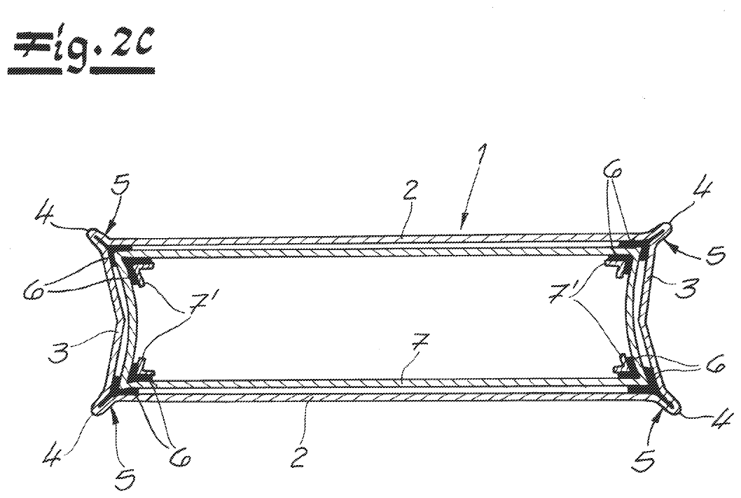

The precise manner of the formation of the reinforcement folds 5 can be derived from FIG. 2A, 2B, 2C, wherein the packaging bag shown in FIG. 1 has reinforcement folds 5 that are configured in the manner of the left side of FIG. 2A. In this regard, it should be noted that the left side of FIG. 2A, 2B, 2C and the right side of FIG. 2A, 2B, 2C show different embodiment methods of a configuration of the reinforcement folds 5, in each instance, so that accordingly, only half of a bag body is shown in each embodiment, in each instance.

According to FIG. 2A, the packaging body 1 is formed by way of a tubular pre-blank, so that the material of the front walls 2 makes a homogeneous transition into the side walls 3 at the longitudinal edge 4. Excepted from this is the overlap seam 8, by way of which the bag body 1 is closed along the longitudinal direction L. In the example shown, the overlap seam 8 is arranged next to a reinforcement fold 5, wherein the fixation takes place by means of an adhesive. The overlap seam 8 is formed from a glue or dispersion adhesive. Fundamentally, however, this can also be a hot-melt adhesive, wherein a dispersion adhesive is preferred.

For formation of the reinforcement folds 5, according to FIG. 2A an adhesive layer 6 composed of a hot-melt adhesive contact adhesive is provided on the left side, in each instance, which layer is arranged at least in part within the assigned reinforcement fold 5, and connects the assigned material sections of the front wall 2 and of the side wall 3 directly with one another. A glue is also possible as an adhesive.

According to the right side of FIG. 2A, introduction of an adhesive layer 6 directly into the reinforcement fold 5 does not take place. Instead, an additional material ply 7 in strip form is fixed in place above an adhesive layer 6 outside of the reinforcement fold 5, on material sections of the front wall 2 and of the side wall 3, and thereby the reinforcement fold 5 is also held in position. The additional material plies 7 thereby cover an opening of the reinforcement fold 5 that runs in the longitudinal direction L, wherein regions between the additional material plies 7 are free of additional material.

In total, it is shown using FIG. 2A that in the case of the bag body 1, only fixation layers in the form of adhesive layers 6 are arranged in the region of the reinforcement folds 5, wherein regions of the bag body 1 between the reinforcement folds 5 are free of an adhesive layer 6. An embodiment without an adhesive layer 6 between the reinforcement fold 5 is particularly preferred within the scope of the invention. In particular, the reinforcement fold 5 can subsequently be cut open in a simple manner, in that the additional material plies 7 are removed or cut open.

This holds true in the same way for the embodiment variants of FIGS. 2B and 2C. According to FIG. 2B, an additional material ply 7 is also provided, but this is now not configured in strip form, but rather encloses the front walls 2 and the side walls 3 within the bag body 1. Thereby this additional material ply 7 represents the actual inner wall of the bag body 2, which stands in direct contact with the goods filled into it. According to the left side of FIG. 2B, this additional material ply 7 is connected with the assigned material sections of the front walls 2 and of the side walls 3 by way of an adhesive layer 6, in each instance, in the region of the corresponding reinforcement seam 5, wherein fixation of the reinforcement fold 5 in the manner of the embodiment form takes place on the right side of FIG. 2A. In contrast to the strip-shaped embodiment of the additional material plies 7, however, merely one continuous material ply 7, not multiple material plies 7 arranged next to one another, needs to be arranged on the material web that forms the bag body 1 during the course of production.

According to the right side of FIG. 2B, two material plies 7, 7′ are provided, which are arranged one on top of the other or one inside the other in the region of the reinforcement folds 5. In this regard, the point of departure is an embodiment according to the right side of FIG. 2A, wherein now a material ply 7′ that lies on the inside is additionally provided, which ply encloses the front walls 2 and the side walls 3. In order to be able to close off both the bag body 1 and the additional material ply 7′, overlap seams 8, 8′ are provided, wherein the overlap seam 8 closes off the bag body 1, and the overlap seam 8′ closes off the material ply 7′. In the example shown, the overlap seams 8, 8′ are formed from a glue or dispersion adhesive, wherein fundamentally a hot-melt adhesive is also conceivable as an alternative.

FIG. 2C shows a further embodiment variant, wherein this time, for the sake of simplicity, no overlap seams 8, 8′ are shown, wherein an arrangement can take place in a manner analogous to FIGS. 2A and 2B. The starting point for the embodiment according to FIG. 2C is formed by the representation on the left side of FIG. 2B, according to which an additional material ply 7 that encloses the front walls 2 and the side walls 3 is attached to the bag body 1 by way of an adhesive layer 6. For fixation, strip-shaped material plies 7′ as well as an adhesive layer 6 are then provided directly in the reinforcement fold 5, wherein the material plies 7′ are arranged in a manner analogous to the representation on the right side of FIG. 2A, but now fix the regions of the additional material ply 7 that reach into the reinforcement fold 5 in place in this position and stabilize them.

All the bag bodies 1 shown are furthermore formed entirely of paper, wherein this is a kraft paper. Fundamentally, however, it is also possible that the outer side, for example, is formed from a coated paper; this is of particular advantage with regard to imprintability.

Although only a few embodiments of the present invention have been shown and described, it is to be understood that many changes and modifications may be made thereunto without departing from the spirit and scope of the invention.

What is claimed is:

1. A packaging bag having a bag body formed of paper, the bag body having front walls that lie opposite one another, side walls arranged between the front walls, and longitudinal edges that connect the front walls with the side walls, wherein a material section that forms one of front walls and a material section that forms one of the side walls are connected with one another on one of the longitudinal edges by way of a fixation layer that borders on the longitudinal edge to form a reinforcement fold that runs in a longitudinal direction (L),
wherein the fixation layer is an adhesive layer, and wherein regions of the bag body between reinforcement folds are free of an adhesive layer.

2. The packaging bag according to claim 1, wherein the adhesive layer is formed from a glue or from a hot-melt adhesive.

3. The packaging bag according to claim 1, wherein the adhesive layer is arranged, at least in part, within the reinforcement fold, and directly connects the material sections of the respective front wall and side wall directly with one another.

4. The packaging bag according to claim 1, wherein the adhesive layer is arranged outside of the reinforcement fold, at least in part, and at least one additional material ply formed of paper connects the material sections of the front wall and side wall with one another.

5. The packaging bag according to claim 4, wherein the at least one additional material ply is structured in strip form and extends only in the longitudinal direction in a region of the reinforcement fold.

6. The packaging bag according to claim 4, wherein the at least one additional material ply encloses the front walls and the side walls.

7. The packaging bag according to claim 4, wherein the at least one material ply comprises at least two material plies that are arranged one on top of the other.

8. The packaging bag according to claim 4, wherein at least one material ply extends into the reinforcement fold in certain sections.

9. The packaging bag according to claim 1, wherein the bag body or at least one layer of the bag body is formed from a kraft paper.

10. The packaging bag according to claim 1, wherein at least the front walls have a sealable coating in a head region and/or in a bottom region on an inner side of the bag body.

11. A method for the production of a packaging bag, comprising the following steps:
supplying a material web in a production direction,
pressing the material web in at multiple positions that are spaced apart from one another in a transverse direction, to form reinforcement folds,
applying an adhesive layer to the material web in a region of each of the reinforcement folds, which layers fix the reinforcement folds in place in the material web,
forming a material tube having front walls that lie opposite one another, side walls arranged between the front walls, and longitudinal edges that connect the front walls with the side walls by means of folding of the material web, and
cutting off individual bag bodies from the material tube.

12. The method according to claim 11, wherein the adhesive layers are introduced into the reinforcement folds, at least in certain sections, and for fixation, material sections of the material web that lie opposite one another are directly connected with one another by way of the adhesive layer, in a region of the reinforcement folds.

13. The method according to claim 11, wherein one or more additional material plies are connected with the material web by way of the adhesive layers, wherein the material plies are arranged on the material web in such a manner that they cover the reinforcement folds.

14. The method according to claim 13, wherein multiple material plies are laid onto the material web, one on top of the other.

15. The method according to claim 11, wherein after the step of folding of the material web to form a material tube, an overlap region that runs along the production direction forms.

16. The method according to claim 11, wherein a heat-sealable coating is applied to an inner side of the bag body in multiple sections that are arranged one behind the other in the production direction.
